(19) United States
(12) Patent Application Publication
(10) Pub. No.: US 2007/0017078 A1
(43) Pub. Date: Jan. 25, 2007

(54) Valve spring compressor tool adapter

(76) Inventor: Albert J. Kolano, West Finley, PA (US)

Correspondence Address: MCKAY & ASSOCIATES, PC., 801 MCNEILLY ROAD, PITTSBURG, PA, 15226, US

(21) Appl. No.: 11/243,260

(22) Filed: Oct. 4, 2005

Related U.S. Application Data
(60) Provisional application No. 60/699,191, filed on Jul. 14, 2005.

(51) Int. Cl. B23P 19/04

(52) U.S. Cl. 29/219

(57) ABSTRACT

In combination with a C-clamp type valve spring compressor, an adapter, comprising a circular proximal plate having a top surface and a concentric proximal hole; multiple vertical support members having proximal and distal ends, the proximal ends are integrally attached to the top surface of the proximal plate and equally spaced circumferentially around the proximal hole; a distal plate equal in diameter to the proximal plate further having a concentric distal hole equal in diameter to the proximal hole; the distal ends of the vertical support members are integrally attached to the bottom surface of the distal plate; wherein the adaptor is symmetrical about both an x-y plane and a y-z plane such that either the distal plate or the proximal plate may contact the valve spring, and wherein the support members define three areas of equal width for variable access points to the spring keeper of the valve spring.

### SPECIFIC REFERENCE

This application hereby claims the benefit of provisional application Ser. No. 60/699,191, filed on Jul. 14, 2005.

### BACKGROUND

1. Field of the Invention

The present invention relates to adapters for use with C-clamp type valve spring compressor tools. Particularly, what is provided is a tool adapted to aid in the depression of valve springs within engine cylinder head recesses.

2. Description of the Related Art

Known in the automotive mechanic industry are C-clamp compression tools configured to facilitate the depression of the valve springs, which are housed within the recesses of the engine cylinder heads. The typical valve assembly includes a spring that operates against the valve stem to hold the valve head in a closed position, functioning opposite the cam and intake. The spring must be compressed because a keeper or other type of retaining assembly must be removed from the spring guide for removal of the valve spring for replacement or repair. Accordingly, as shown by U.S. Pat. No. 4,376,331 for example, the typical C-clamp compression tool comprises an adjustable, lower jaw portion for engaging the spring at its uncompressed position. The tool is thus placed over the valve spring in the recess, adjusted to match the valve spring width so that the valve spring abuts the jaws of the elongated arm, and then the tool is actuated by rotation of the threaded arm.

These traditional C-clamp type compressors are not well-suited to function with all the various cylinder heads, for instance with certain types of overhead cam engines or L-head engines, wherein the valve spring housing may be considerably recessed within the cylinder head casting. In other instances when the engines are relatively small, the jaw-like attachments of the C-clamp tools simply cannot effectively access the springs. However, because these C-clamp devices are still very effective for older model engines where the valve springs are still exposed but not easily accessible, attempts have been made to provide extender-type attachments adapted to be used in conjunction with the C-clamp tools.

More particularly, U.S. Pat. No. 4,267,627 is an attachment for a valve spring depressing tool that enables the use of the above common valve spring tool for selectively depressing valve return springs. The generally L-shaped attachment in use is inefficient as it must be properly positioned in one direction and fixed to the elongated leg portion of the C-clamp using screws or bolts, prior to use. This L-shape construction further is not structurally adequate.

U.S. Pat. No. 4,654,944 is an overhead cam valve spring compressor adapter. The adapter is cylindrical, and positioning it properly is time-consuming because only a single lateral opening within this cylindrical body provides access to the collets, also known as the keeper, which secure the spring in place. It would further be difficult to match the appropriate size adaptor to the specific type of cylinder since the small lateral opening is the sole means for allowing mechanical work to be performed within the cylinder.

There is a need then for an adapter tool for use with a C-clamp valve spring compressor which is configured symmetrically along both the x-y and y-z planes of the tool to allow for ease of use and which is further configured to provide easy access to the keeper when the spring is depressed.

### SUMMARY

What is provided then is, an adapter tool used in combination with a C-clamp type valve spring compressor comprising, a circular proximal plate having a top surface and a concentric proximal hole; multiple vertical support members each having a proximal end and a distal end, wherein each proximal end is integrally attached to the top surface of the proximal plate and equally spaced circumferentially around the proximal hole; a distal plate equal in diameter to the proximal plate having a concentric distal hole equal in diameter to the proximal hole; wherein each distal end of each support member is integrally attached to the bottom surface of the distal plate; wherein the adaptor tool is symmetrical about an x-y plane and a y-z plane such that either the distal plate or the proximal plate may contact a valve spring; and, wherein the support members define multiple areas of equal width for variable access points to a spring keeper of the valve spring.

In the preferred embodiment there are three vertical support members which define three areas of equal width for variable access points to a spring keeper of said value spring.

In use, either the proximal plate or the distal plate is quickly situated within the jaw of the C-clamp tool, with the opposing plate aligned with the valve spring such that upon adjustment of the screw head or other compression means against the valve, the valve spring will compress to facilitate the removal of the spring by allowing access to the spring keeper from a variety of angles as the spring guide penetrates the hole on the proximal plate. Thus, in comparison with the prior art, full access to the top of the valve after compression is achieved, thus allowing manipulation of the keepers.

### BRIEF DESCRIPTION OF THE DRAWINGS

FIG. 1 is a perspective view showing the C-clamp valve compression tool which is used in combination with the present adapter tool invention.

FIG. 2 is a perspective view showing the adapter tool in more detail.

FIG. 3 is a top view of the adapter tool showing the concentric hole for receiving the spring guide.

FIG. 4 is a side view of the adapter tool showing the support members.

FIG. 5 is a cross-sectional view of a cylinder head showing the adapter tool in use within the jaws of the C-clamp tool.

### DETAILED DESCRIPTION OF THE PREFERRED EMBODIMENT

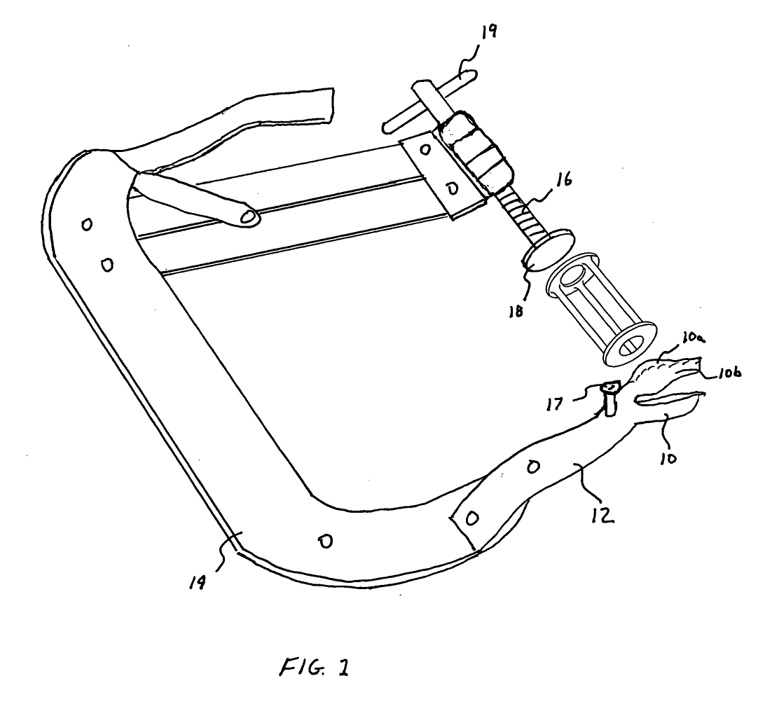

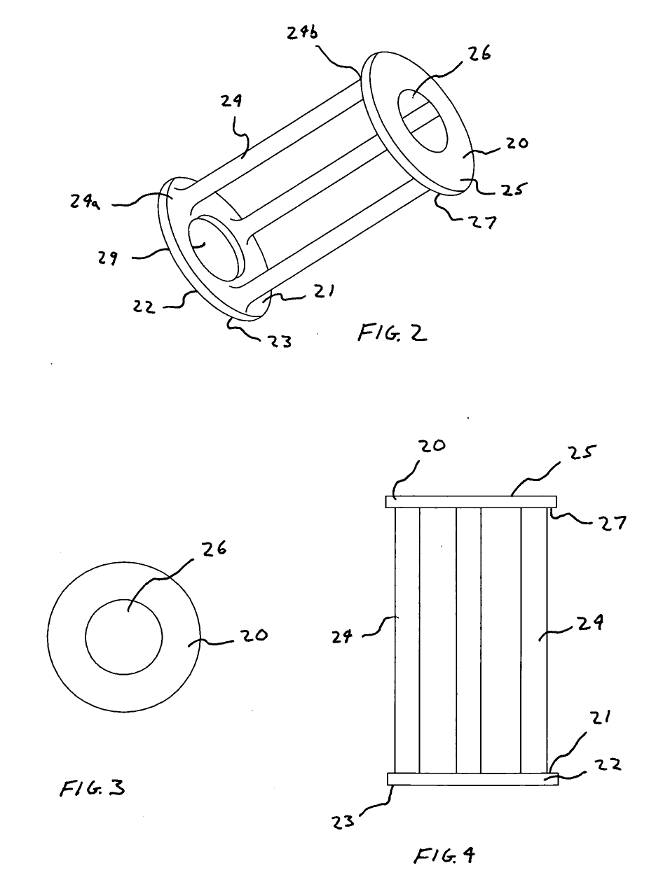

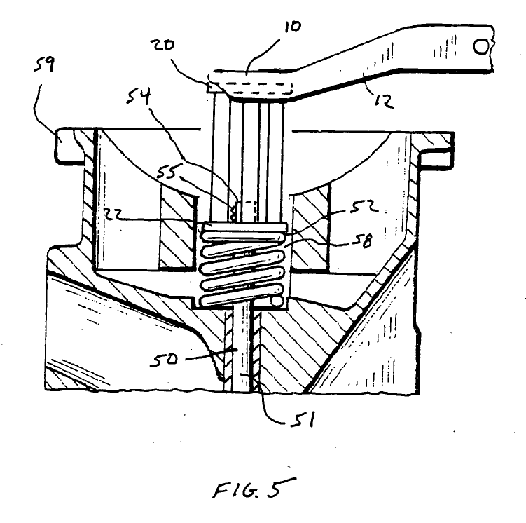

With reference to FIGS. 1-5, the invention is suited to function in combination with a C-clamp type valve spring compressor. In the preferred embodiment, the C-clamp tool has a C-frame 14 with an elongated arm 12 extended from the bottom of the C-frame 14. A jaw 10 is formed integrally to the arm 12, which further includes an adjustment means 17. In the preferred embodiment, the jaw 10 is bifurcated to define two abutment surfaces 10a each having a raised lip 10b. Thus, the abutment surfaces 10a and raised lips 10b are adapted to contact the present adapter when in use. Traditionally, the jaw 10 is positioned on the top of a valve spring and adjusted, after which the screw head 18 or other rod-like abutment means is positioned on the opposing valve head and compressed using handle 19.

Although not limited to one particular type of tool, such types of traditional C-clamp tools well-suited to work in conjunction with the present adapter tool invention are the valve spring compressors manufactured by KD Tool, tool numbers 385 and J-802 for example. Frequently, the jaws of such a tool cannot access every type of valve spring, especially in the instance the valve spring resides deep within the recess of the cylinder.

Accordingly, in combination with the C-clamp tool, the present invention is an adapter configured to be positioned in the jaw 10 and to contact the valve spring for compression as an alternative to the jaw 10, thereby acting as an extension.

A circular proximal plate 22 has a top surface 21 and a concentric proximal hole 29. Multiple vertical support members 24 have proximal ends 24a and distal ends 24b. In the preferred embodiment, there are three multiple vertical support members 24 (arranged in triplicate), although any other number may be used. The proximal ends 24a are integrally attached to the top surface 21 of the proximal plate 22 and equally spaced circumferentially around the proximal hole 29. A distal plate 20 equal in diameter to the proximal plate 22 further has a concentric distal hole 26 equal in diameter to the proximal hole 29. The distal ends 24b of support members 24 are integrally attached to the bottom surface 27 of the distal plate 20.

As a result of this adapter tool configuration, the adapter is symmetrical about both an x-y and y-z plane (for instance with the x-y plane viewed medially and transaxially and a y-z plane viewed medially and axially relative to the centers of each plate) such that either the distal plate 20 or the proximal plate 22 may contact the valve spring 52, and wherein the support members 24 define three areas of equal width for variable access points to the spring keeper of the valve spring 52. In other words, depending on the location of the cylinder or the mechanic working on the engine, the spring keeper 54 can be removed from the most efficient direction. Full access to the top of the valve after compression is achieved by the present invention, thus allowing better manipulation of the keepers 54.

In use then, with reference to FIG. 5, either the proximal plate 22 or distal plate 20 is easily situated within the bifurcated jaw 10 of the C-clamp tool, abutting the abutment surfaces 10a and lips 10b thereof, with either opposing plate aligned with the valve spring 52 such that upon adjustment of the screw head 18 or rod against the valve, the valve spring 52 will compress to facilitate the removal thereof by allowing access to the spring keeper 54 from a variety of angles as the spring guide 50 penetrates either hole on the adapter tool.

Preferably all components of the adaptor are made of steel, although as would be understood by one skilled in the art, any hard metal, metal alloy, hard plastic or any other similar material may be used depending on the compression force of the spring. Furthermore, the length of the support members 24 may vary. As such, it is envisioned that due to the ease at which the length of the adaptor may vary, the invention may be provided as a kit of different adaptors, varying in length or outside diameter according to the type of cylinder head each is best adapted to work with. For instance, each adaptor may be numbered to correspond to a specific type of engine as designated in some type of numerical legend, database or the like. In one embodiment, the kit of the present invention would comprise the adapters sized in accordance with table 1 below:

TABLE 1

| Adapter Size | Length(inches) | Outside Dia.(inches)* |
|---|---|---|
| Small | 1 11/16 | 1¼-0.02 |
| Small | 1 11/16 | 1-0.02 |
| Large | 2¾ | 1¼-0.02 |
| Large | 2¾ | 1-0.02 |

*The outside diameter can be shaved or polished down 0.02 inches after sizing, thus the outside diameter range can be defined as being about 1-1¼ inches.

The invention as described in detail as above is in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

I claim:

1. In combination with a C-clamp type valve spring compressor including a C-frame, an arm attached to said C-frame, a bifurcated jaw extending from said arm having abutment surfaces and further comprising a jaw adjustment means mounted on said jaw for adjusting said jaw;
an adapter tool for said spring compressor, comprising:
a circular proximal plate having a top surface and a concentric proximal hole;
multiple vertical support members each having a proximal end and a distal end, wherein each said proximal end is integrally attached to said top surface of said proximal plate and equally spaced circumferentially around said proximal hole;
a distal plate equal in diameter to said proximal plate having a concentric distal hole equal in diameter to said proximal hole, each said distal end of each said support member integrally attached to a bottom surface of said distal plate;
wherein said adaptor tool is symmetrical about an x-y plane and about a y-z plane such that either said distal plate or said proximal plate may contact said valve spring or said abutment surfaces of said bifurcated jaw; and,
wherein said support members define multiple areas of equal width for variable access points to a spring keeper of said valve spring.

2. The adapter tool of claim 1, wherein said vertical support members are arranged in triplicate to define three areas of equal width.

3. An adapter tool used in combination with a C-clamp type valve spring compressor consisting of:
a circular proximal plate having a top surface and a concentric proximal hole;
three vertical support members each having a proximal end and a distal end, wherein each said proximal end is integrally attached to said top surface of said proximal plate and equally spaced circumferentially around said proximal hole;
a distal plate equal in diameter to said proximal plate having a concentric distal hole equal in diameter to said proximal hole;
wherein each said distal end of each said support member is integrally attached to a bottom surface of said distal plate;
wherein said adaptor tool is symmetrical about an x-y plane and about a y-z plane such that either said distal plate or said proximal plate may contact a valve spring; and,
wherein said support members define three areas of equal width for variable access points to a spring keeper of said valve spring.

4. An adapter tool kit, comprising:
at least two adapter tools, each said adapter tool varying in length or outside diameter and further comprising;
a circular proximal plate having a top surface and a concentric proximal hole;
multiple vertical support members each having a proximal end and a distal end, wherein said proximal end is integrally attached to said top surface of said proximal plate and equally spaced circumferentially around said proximal hole;
a distal plate equal in diameter to said proximal plate having a concentric distal hole equal in diameter to said proximal hole;
wherein each said distal end of each said support member is integrally attached to a bottom surface of said distal plate;
wherein said adaptor tool is symmetrical about an x-y plane and about a y-z plane such that either said distal plate or said proximal plate may contact a valve spring; and,
wherein said support members define multiple areas of equal width for variable access points to a spring keeper of said valve spring.

5. The adapter tool kit of claim 4, wherein said vertical support members are arranged in triplicate to define three areas of equal width.

6. The adapter tool kit of claim 4, wherein said length is in the range of 1 11/16 inches to 2¾ inches.

7. The adapter tool kit of claim 4, wherein said outside diameter is in the range of about 1 inch to 1¼ inches.

8. The adapter tool kit of claim 4, further comprising said adapter tools being numbered to correspond to a specific type of engine.
